(19) United States
(12) Patent Application Publication
(10) Pub. No.: US 2009/0110060 A1
(43) Pub. Date: Apr. 30, 2009

(54) Method and apparatus for performing lower complexity multiple bit rate video encoding using metadata

(76) Inventors: Mauricio Cortes, Scotch Plains, NJ (US); James William McGowan, Flemington, NJ (US)

Correspondence Address: Docket Administrator - Room 2F-192;Alcatel-Lucent USA Inc., 600-700 Mountain Avenue, Murray Hill, NJ, 07974, US

(21) Appl. No.: 11/978,817

(22) Filed: Oct. 30, 2007

(51) Int. Cl. H04N 7/24

(52) U.S. Cl. 375/240.02; 375/E07.002

(57) ABSTRACT

A Multiple Bit Rate (MBR) video encoding system wherein a first video encoding at a first bit rate is performed based on the original video source material, and wherein the first video encoding generates and saves metadata relating to the encoding process. In typical block-based motion-compensated video encoding techniques, this metadata may comprise block motion search information including motion vectors and error information. This saved metadata is then used during one or more subsequent encodings at different bit rates to generate a plurality of video encodings at different bit rates. This approach provides a more efficient MBR video encoding system realization than by encoding at each bit rate independently.

### FIELD OF THE INVENTION

The present invention relates generally to the field of video encoding at multiple bit rates and more particularly to a lower complexity method and apparatus for performing multiple bit rate video encoding.

### BACKGROUND OF THE INVENTION

Multiple bit rate (MBR) video encoding is a modern compression technique useful for delivering video over networks with time-varying bandwidth. MBR codecs (encoder/decoder systems) are used, for example, to provide video over the internet, and are also critical on mobile wireless networks in which the bandwidth available to a user changes dramatically over time. The 3GPP standards organization, for example, is adopting a MBR strategy as a standard for all High Speed Downlink Packet Access (HSDPA) terminals, and this strategy underlies the proprietary streaming formats from the leading vendors which provide streaming video. MBR video encoding techniques are useful because the bit rate of a video signal must be able to adapt to the changing network conditions while gracefully adjusting quality.

In particular, MBR video encoding techniques typically provide for such adaptability to the network conditions by creating a plurality of video sequences (or “copies”), each generated from the same video source material, and having a common set of switching points whereby a video system can switch between the copies. Thus, whenever network conditions change, the playback mechanism advantageously streams the copy that best matches the available bandwidth. Strategies for switching seamlessly between two video copies having different bit rates are conventional and well known to those of ordinary skill in the art.

More specifically, in a typical MBR video system realization, several copies of the same video sequence are pre-encoded at different bit rates, and the playback system selects which video sequence to display from frame to frame. Only certain frames are valid “switching points” in which the decoder can start receiving a different stream and still recreate sensible video. However, current state-of-the-art systems encode each video sequence independently each time at each required bit rate, based only on the original video source material and “from scratch”, only sharing information about which frames may be used as switching points between the multiple encodings. Although this approach results in the maximum possible quality for each bit rate, it is computationally inefficient, since the original video source signal is encoded “from scratch” a plurality of times.

### SUMMARY OF THE INVENTION

The instant inventors have recognized that significant efficiency can be gained in a MBR video system realization by initially generating a “first” encoded video sequence at a first bit rate from the original video source material, but then advantageously generating other encoded video sequences having bit rates different from the first bit rate based at least in part on certain (e.g., intermediate) results obtained from the “first” encoding (i.e., the generation of the first encoded video sequence at the first bit rate). More specifically, the inventors have recognized that in typical block-based motion-compensated video encoding techniques, the bulk of the encoding complexity, and the bulk of the coding efficiency, occurs as a result of the encoder's performing a search for blocks of pixels that have moved between frames. Although the results of this search can theoretically differ between versions which have been encoded at different bit rates (and this has been a factor in most MBR video system encoder designs), the best or near-best motion vector will often be the same between all versions.

In particular, in accordance with an illustrative embodiment of the invention, a first video encoding is performed based on the original video source material, wherein the first video encoding generates and provides, inter alia, metadata relating to the encoding process. For example, in typical block-based motion-compensated video encoding techniques, this metadata may advantageously comprise block motion search information including motion vectors and error information. In accordance with the principles of the present invention, this metadata is then used during one or more subsequent encodings (at different bit rates) to provide a more efficient MBR video encoding system realization.

### BRIEF DESCRIPTION OF THE DRAWINGS

FIG. 1 shows a prior art process for the realization of a MBR video encoding system.

FIG. 2 shows a process for the realization of a MBR video encoding system in accordance with an illustrative embodiment of the present invention.

FIG. 3 shows various block structures which may be employed in connection with the video coding standard H.264. FIG. 3A shows a single 16×16 block; FIG. 3B shows two 8×16 blocks; FIG. 3C shows two 16×8 blocks; FIG. 3D shows four 8×8 blocks; FIG. 3E shows eight 4×8 blocks; FIG. 3F shows eight 8×4 blocks; and FIG. 3G shows sixteen 4×4 blocks.

FIG. 4 shows a prior art approach to deriving a motion vector in a conventional block-based motion-compensated video encoding technique such as, for example, video coding standard H.264.

FIG. 5 shows a method for generating and storing metadata results from a first video encoding process in accordance with an illustrative embodiment of the present invention.

FIG. 6 shows a method for performing a subsequent video encoding process, using metadata results generated from a first video encoding process, in accordance with an illustrative embodiment of the present invention.

### DETAILED DESCRIPTION OF THE PREFERRED EMBODIMENTS

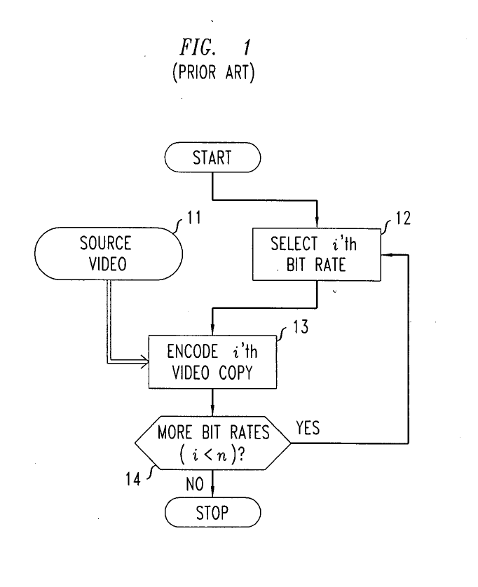

FIG. 1 shows a prior art process for the realization of a MBR video encoding system. First, source video 11 and the i'th bit rate (selected by block 12) in a series of n desired bit rates are fed into encoder 13, which generates the i'th encoded copy of the video, where i=1, 2, . . . , n. If there is another bit rate to encode, as determined by decision block 14, the process repeats at block 12 with the selection of the next bit rate in the series. If all n bit rates have been encoded, the process terminates. Note that no information is saved between encodings, and indeed, an entirely separate encoder, independent of the others and of any information generated by the others, could be used to generate each encoded copy of the video.

In accordance with the principles of the present invention, however, some of the codec information generated by a first one of these video encodings is advantageously saved as metadata along with the resultant encoded copy of the video. Then, this saved metadata is advantageously used in subsequent encodings at different bit rates. Illustratively, for use with typical block-based motion-compensated video encoders, this metadata may, for example, include the results of motion searches which were performed by the first video encoding.

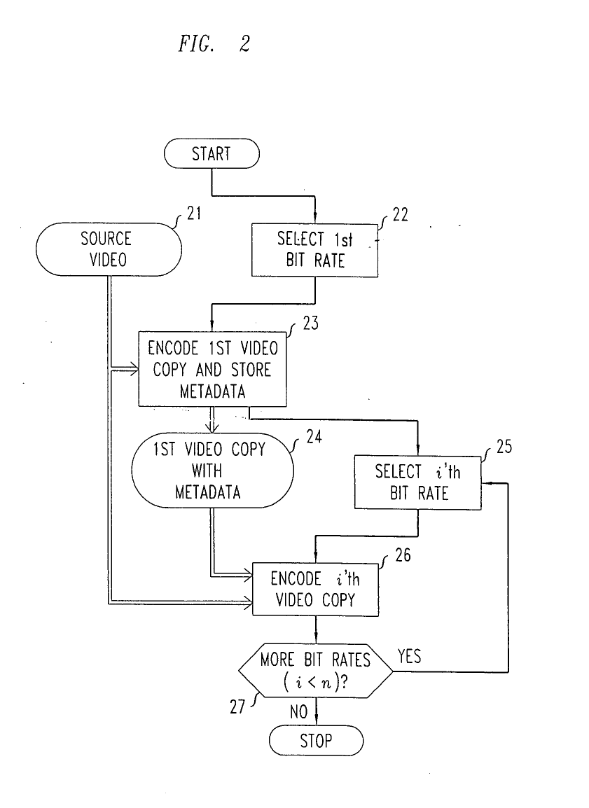

FIG. 2 shows such a process for the realization of a MBR video encoding system in accordance with an illustrative embodiment of the present invention. The first bit rate (selected by block 22) to be encoded, which is typically and most advantageously the highest quality one, is fed into encoder 23 with the source video 21. In accordance with the principles of the present invention, output 24 of the encoder includes both the encoded video and metadata (e.g., motion search results) generated by the encoding process. Then, also in accordance with the principles of the present invention, these data are repeatedly fed into encoder 26 (which may be the same as or different than encoder 23, or may comprises a series of multiple encoders), along with the i'th bit rate (selected by block 25), which generates the i'th encoded copy of the video, where i=2, 3, . . . , n. Finally, if there is another bit rate to encode, as determined by decision block 27, the process repeats at block 25 with the selection of the next bit rate in the series. If all n bit rates have been encoded, the process terminates.

To continue, it is appropriate to review some general information about the operation of typical video encoders. All common standardized video encoders, including, for example, MPEG-1, MPEG-2, MPEG-4, H.263 and H.264, each of which is fully familiar to those of ordinary skill in the art, are blocked-based, which means that they divide a single video frame into rectangles of pixels (of sizes such as 8×8 or 16×8, etc.). For each such block, a decision is made to either “intracode” or “intercede” that block. Intracoding means that the block's pixel values will be represented independently, without explicit reference to any other piece of the video. Intercoding on the other hand, means that each block is represented with reference to another block, typically one contained in a different frame; therefore, a corresponding decoder must decode a first block to decode the second block (although in some cases the “first” block may be part of a frame which is a later frame of video than the frame containing the “second” block, as certain types of frames are intentionally coded out-of-order).

Intracoding uses far more bits than intercoding, provided that a reasonably similar block can be found in the latter case. This is because in order to represent one block in terms of another, it is only necessary to identify the other block and specify any differences therebetween. To find such reasonably similar block (i.e., a “match”), interceding involves a costly three-dimensional search in which the block to be coded is compared to blocks in many different positions in one or more different video frames. Then, if a close match is found, the absolute difference or “error” between the two blocks will be mostly zeroes (and can therefore be very efficiently coded using well-known entropy coding techniques), and a “motion vector” can be used to indicate the displacement of the block between the two frames. To recreate the interceded block, the decoder simply has to decode the error block and add it to the previously decoded block as indicated by the motion vector.

The quality of a match is determined by how costly the error block is to encode (and to a much lesser extent on the size of the motion vector). Blocks for which no good match can be found will have error blocks that cannot be efficiently represented, and so the block would be more preferably intracoded. However, when there is little correlation between the frames, often due to a lot of motion or a scene change, the encoder will often decide to intracode, in which case it may well exceed the target bit rate. Therefore, the encoder may be forced to intercede while only coarsely representing the error block, resulting in visible degradations.

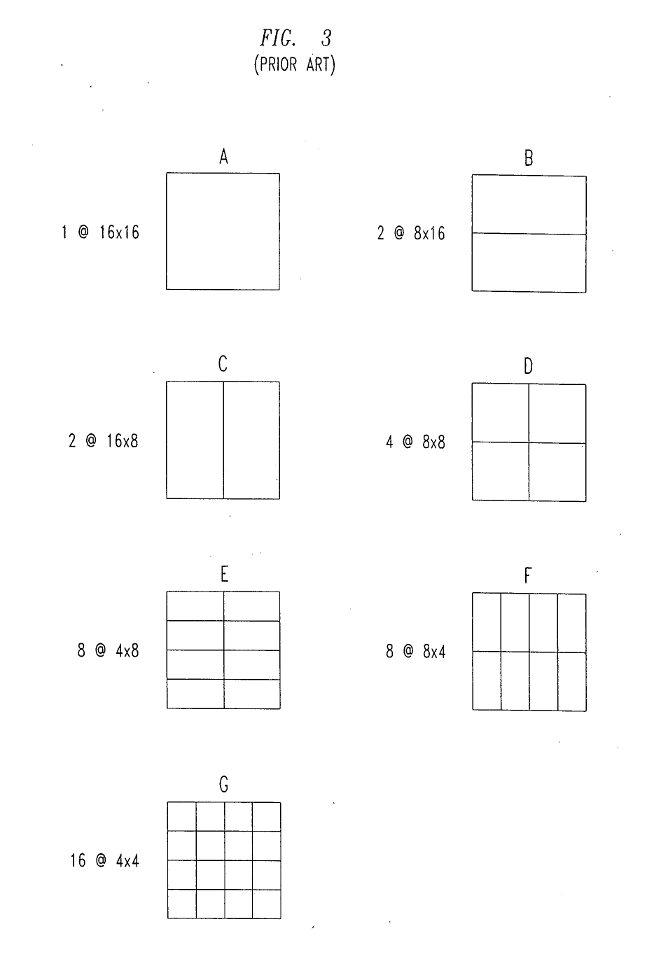

In H.264, for example, which specifically supports MBR encoding techniques, coding gains are increased by allowing the block size to be treated as sets of smaller blocks. This significantly increases the “search space”, as there are up to 41 different blocks of varying sizes that an H.264 encoder must search for a best match. (See the discussion of FIG. 3 below.)

A search typically starts with a 16×16 pixel search block, and a SAD (Sum of the Absolute Differences) is calculated between the pixels in the search block and each one of the target blocks. Frequently, an encoder starts by computing a SAD for the target block against the same the block in the same location in a different frame, or against a block in the average motion vector offset for surrounding blocks. SADs are also taken for blocks either surrounding these targets or in other places until a close match is found. (Note that, since an exhaustive search is computational intractable, there are many motion search strategies, including hierarchical, “diamond” and heuristic searches, each of which is familiar to those of ordinary skill in the art.) Sub-pixel interpolation may be used to determine if a better match is found at some non-integer disposition of pixels (e.g., 2.5 pixels to the left, 3.75 pixels down, and 1 frame back). All of this occurs between the current frame and a set of reference frames.

If the SAD between any of these best matches is more than zero, indicating a less than perfect match, then the encoder can continue to search, for example, by dividing the block hierarchically. FIG. 3 shows various block structures which may be employed in connection with the video coding standard H.264. As illustrated in the figure, first a 16×16 block is considered (as illustrated in FIG. 3A), and a motion search is performed across a wide range of blocks and reference frames. If no match yields a small enough SAD, two separate motion searches are considered on each of the two 8×16 (as illustrated in FIG. 3B) and each of the two 16×8 blocks (as illustrated in FIG. 3C). If none of these yields a sufficiently low SAD, then a motion search is considered for the set of four 8×8 blocks (as illustrated in FIG. 3D). Searching continues through smaller blocks (as illustrated in FIGS. 3E and 3F) until a small enough SAD is found, thus terminating the hierarchy prematurely, or until 16 separate 4×4 motion searches are performed (as illustrated in FIG. 3G). At the end of the search, the match that can be coded most efficiently is chosen, and the encoder repeats the entire process on the next block to be encoded. Note that the encoder must weigh the size of the error block when entropy coded as well as the bits necessary to deliver the motion vectors, which is necessarily larger as the number of motion vectors grows.

There are numerous optimizations and strategies that can be used to reduce the search space, many of which are well known and fully familiar to those of ordinary skill in the art. However, for prior art MBR video encoding systems, the maximum information currently available to a secondary encoder is the result of the motion search that was ultimately selected in the primary encoding, assuming the primary encoding is available. In other words, all an encoder knows, assuming it receives a previously encoded stream, is the motion vectors and the error block of intercoded blocks. From these error blocks the original SAD can only be estimated, since quantization and rounding errors will result in decoded pixels that do not perfectly match the originals.

Within this instructive strategy, it becomes clear that lower quality streams can differ by the number of intracoded blocks. These decisions are made at the video encoder making the primary copy, and, in prior art systems, are not available for the encoder making additional copies (at different bit rates). In fact, the entire motion decomposition is discarded by prior art MBR systems, even though these searches are likely to be the best results in each copy across a wide range of bit rates. In addition, the encoder producing a lower quality copy may decide that the error associated with a sparser coding, using fewer motion vectors is now appropriate. In accordance with the illustrative techniques of the present invention, the search can be avoided completely for many blocks by using the saved metadata, thereby reducing complexity at the encoder (by as much as 90% or more) relative to prior art optimized search strategies. In accordance with certain illustrative embodiments of the present invention, an additional complexity reduction may be achieved using the SAD information, which can be advantageously used to determine which motion vectors in the hierarchy are likely to provide the best estimates.

More specifically, in accordance with the principles of the present invention and certain illustrative embodiments thereof, the motion search information is saved as metadata along with an encoded copy of the video. Illustratively, motion search information may be saved for both the intermediate results of the hierarchical decomposition as well as for the final results for blocks that are ultimately intracoded. For each of these, both the motion vector and the SAD may be advantageously saved. This metadata may then be used by the same or another encoder to substantially reduce the complexity of creating another bit rate encoding (typically much less than half even when used with other optimization strategies). The motion vectors are advantageously saved because they represent a likely (although not guaranteed) best match for a motion vector in any encoded video copy. The SAD can be advantageously used to rank the likelihood that a motion vector will be a good match in subsequent copies. (See discussion below.)

In accordance with certain illustrative embodiments of the present invention, the size of this metadata plus a single high quality copy may be advantageously less than the full collection of copies at different bit rates. Using this explicit information about the codec's initial motion search and decomposition, the video quality and encoding efficiency may be better than alternative techniques which look at information already implicitly stored in the video itself, such as, for example, the motion vectors for interceded blocks. In other words, even without the metadata stored in accordance with the principles of the present invention, a codec could, in theory, simply check for a match using the motion vector for an interceded block, and if it still works, use it again. However, in accordance with the above-described illustrative embodiments of the present invention, the additional option of using motion vectors even when they are discarded is also available, such as, for example, the motion vectors generated during the hierarchical decomposition.

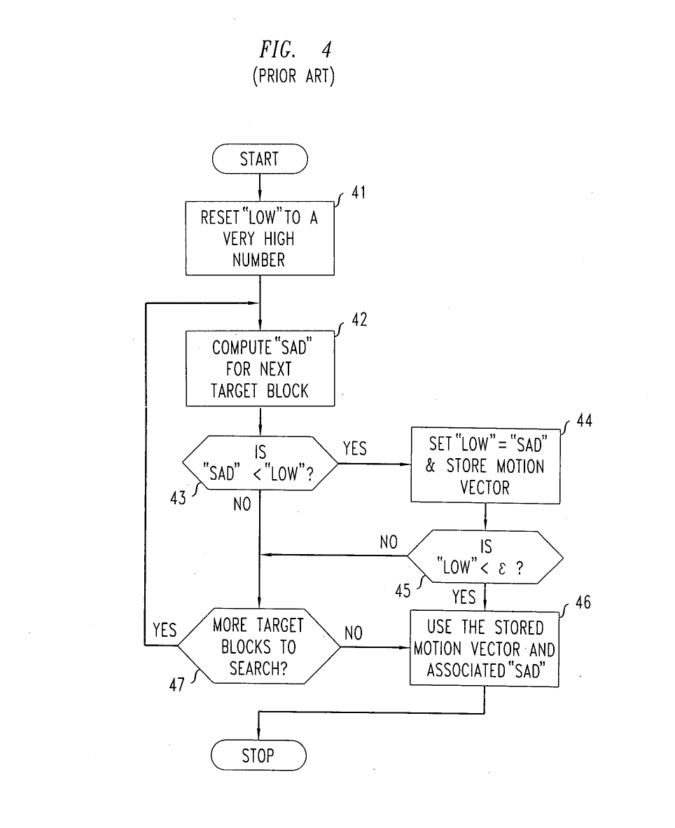

FIG. 4 shows a prior art approach to deriving a motion vector in a conventional block-based motion-compensated video encoding technique such as, for example, video coding standard H.264. Specifically, the figure shows this prior art motion vector search process for a single source block in an image against a range of possible matching target blocks.

First, given a single source block (of any size) in an image to be encoded, block 41 of the flowchart resets a variable, LOW, to a very high number (i.e., one the is beyond the range of any possible value for the SAD which is to be calculated in the next flowchart block). In block 42 of the flowchart an initial target block or a subsequent search block is selected. There are many well documented methods, such as, for example, exhaustive, “diamond” and heuristic searches, each of which being fully familiar to those of ordinary skill in the art, which may be employed for this purpose.

Once a target block is selected, a SAD is computed (also in block 42 of the flowchart) using this selected block and the given source block. As determined by block 43 of the flowchart, if the SAD is less than the value of the variable LOW (as it always must be on the first iteration), then in block 44 of the flowchart the variable LOW is set to SAD, and the motion vector representative of the target block is stored. In addition (when the SAD has been determined to be less than the value of the variable LOW), block 45 of the flowchart determines whether the value of the variable LOW is less than a predetermined threshold ε (“epsilon”), where epsilon is, for example, half the number of pixels in the sub-block. If it is, then the encoder assumes that it will not (or need not) find a better match with continued searching and stops the search.

If, on the other hand, the variable LOW is determined to be greater than or equal to epsilon (in block 45 of the flowchart), or if block 43 of the flowchart determined that the SAD is greater than or equal to LOW, the search continues in block 47 of the flowchart which checks to see if more target blocks are available (i.e., if there are more blocks to be searched). If there are more blocks to be searched, the process repeats for the next target block by returning the flow to block 42 of the flowchart, which will compute a SAD for this next target block. If, on the other hand, either the variable LOW is less than epsilon (as determined by block 45 of the flowchart), or if there are no more blocks to search (as determined by block 47 of the flowchart), the process stops, and the motion vector will be set in accordance with the best match found, with the LOW variable holding the corresponding SAD for that match.

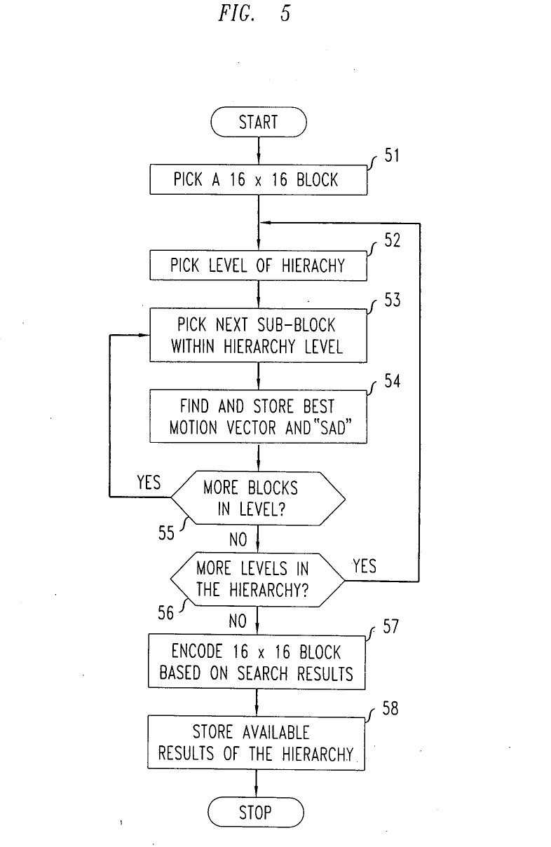

FIG. 5 shows a method for generating and storing metadata results from a first video encoding process in accordance with an illustrative embodiment of the present invention. In particular, the illustrative encoding method of FIG. 5 advantageously implements a hierarchical motion search through the decomposition of a 16×16 block (as illustratively shown in FIG. 3).

First, in block 51 of the flowchart, a 16×16 block is selected for encoding. Next, in block 52 of the flowchart, a level of the hierarchy (as shown, for example, in FIG. 3) is selected, starting with the highest level (which contains the 16×16 block itself), and then iterating “down” to the two-division blocks (i.e., 8×16 and 16×8), etc. Then, in block 53 of the flowchart, the next sub-block within the hierarchy level is selected. (Note that the highest level of the hierarchy has only one such sub-block, but all lower levels have a plurality of such sub-blocks.) In this manner, a 16×16 block will first be selected, then, for example, the upper 8×16 block followed by the lower 8×16 block, then, for example, the leftmost 16×8 block, followed by the rightmost 16×8 block, etc.

Next, in block 54 of the flowchart, the best matching motion vector and the SAD corresponding thereto are found, in a manner which may, for example, comprise the prior art approach as shown in FIG. 4. If there are more sub-blocks on the currently analyzed level of the hierarchy, as determined by block 55 of the flowchart, the process repeats with the next sub-block by returning flow to block 53 of the flowchart. If there are no more sub-blocks on the currently analyzed level of the hierarchy (as determined by block 55 of the flowchart), then if there are more levels in the hierarchy, as determined by block 56 of the flowchart, the process repeats with the next level by returning flow to block 52 of the flowchart.

If there are no more levels in the hierarchy (as determined by block 56 of the flowchart), then the illustrative process of FIG. 5 encodes the originally selected block based on the search results in block 57 of the flowchart. However, note that, in a conventional manner and based on other encoder decisions, intracoding, rather than interceding, may be selected to encode the originally selected block. Finally, in block 58 of the flowchart and in accordance with the principles of the present invention and an illustrative embodiment thereof, the results of the motion hierarchy (i.e., the metadata) are advantageously efficiently encoded and saved. Note that this metadata, illustratively and advantageously comprising the complete results of the motion hierarchy search, may be saved regardless of the coding decision (e.g., intracoding vs. interceding) for the originally selected block as made in block 57 of the flowchart. Note also that a typical prior art encoder, such as that shown in FIG. 4, might also perform the steps of the method of FIG. 5, but would not save the search results as shown in block 58 of the flowchart.

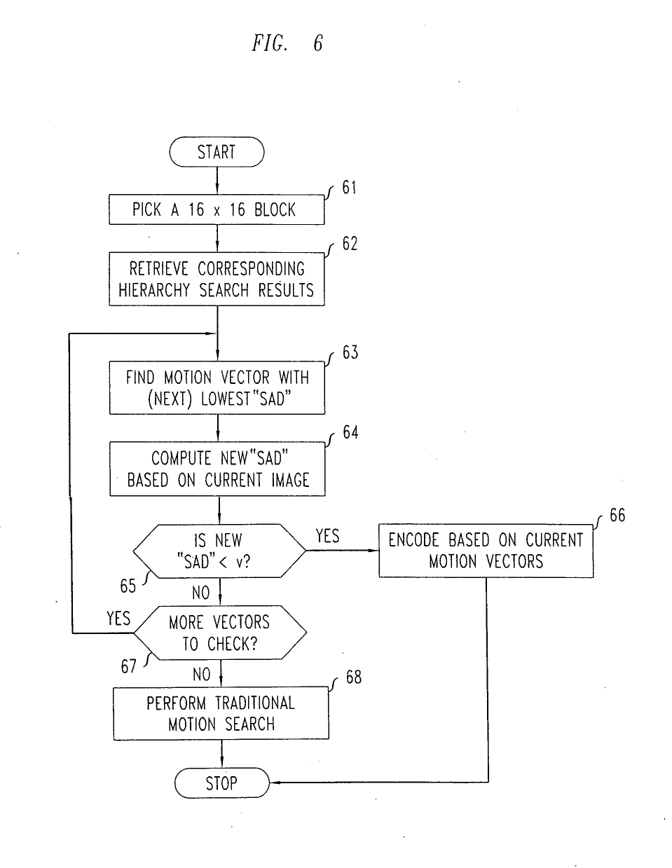

FIG. 6 shows a method for performing a subsequent video encoding process, using metadata results generated from a first video encoding process, in accordance with an illustrative embodiment of the present invention. First, as shown in block 61 of the flowchart, the encoder selects a 16×16 block to encode. Then, as shown in block 62 of the flowchart, the motion hierarchy information (i.e., the metadata) for that block, which had been advantageously saved in accordance with the principles of the present invention and, for example, with use of the illustrative encoder shown in FIG. 5, is retrieved. Next, as shown in block 63 of the flowchart, the motion vector with the lowest SAD is found (for the first iteration), or successively higher values (i.e., the next lowest SAD) in each subsequent iteration. Then, as shown in block 64 of the flowchart, a new SAD is computed based on the current encoding history. Note that even though this value for the SAD is unlikely to be identical to the corresponding saved value, advantageously it will often be very close to the saved value (i.e., the original SAD) given the same motion vectors.

Then, block 65 of the flowchart compares the (newly) computed SAD value to a threshold v (where v is, for example, the number of pixels in the sub-block, or v=2ε). If the SAD value is determined to be less than the threshold v, then that motion vector is used in block 66 of the flowchart to encode the selected 16×16 block. Note that in most cases, particularly where the bit rate has not changed substantially, the originally selected motion vectors will, in fact, match best, and therefore the associated newly computed SAD will, in fact, be less than the threshold v, and will therefore be used to encode the 16×16 block. If, on the other hand, the threshold is exceeded (i.e., block 65 of the flowchart determines that the newly computed SAD is greater than or equal to the threshold v), then, in block 67 of the flowchart, the encoder checks to see if there are more stored motion vectors to check. If there are, then the encoder loops back to block 63 of the flowchart to select the motion vector with the next lowest SAD in the hierarchy. Otherwise, the search of the metadata is abandoned, and a conventional motion search is newly performed in block 68 of the flowchart.

In accordance with one alternative illustrative embodiment of the present invention, the motion vectors from the current search, as performed in the flowchart of the illustrative encoder shown in FIG. 6, may be advantageously saved for use in subsequent encodings. That is, if one had originally encoded at a bit rate b₁, and then re-encoded at bit rate b₂, the motion vectors from b₂, as well as the motion vectors from b₁, could be advantageously used for re-encoding at bit rate b₃. Note that this strategy is likely to work best for bitrates b₁>b₂>b₃.

In accordance with another illustrative embodiment of the present invention, the illustrative encoder of FIG. 6 may be modified so as to only search when the SAD is less than some threshold (e.g., 20), assuming that any larger match is likely to fail the test. Since several thousand SAD values are computed in a typical motion search, it is unlikely that prematurely terminating the search will be much of an optimization. It is also likely that a conventional motion search will eventually cover the same ground as the stored search, thereby eliminating any savings.

In accordance with another illustrative embodiment of the present invention, the illustrative encoder of FIG. 6 may be modified so as to only consider the saved motion searches to be the initial target block in a traditional motion search. In other words, the illustrative encoder of FIG. 6 would proceed as shown, except that block 68 thereof would be replaced with a block specifying that the encoder is to continue with the conventional motion search as if the stored results were the initially searched target blocks.

In accordance with various illustrative embodiments of the present invention, the MBR encoders described herein may be advantageously employed in a number of illustrative scenarios. In one such scenario in accordance with one illustrative embodiment of the present invention, a single video encoder is used to generate all encoded copies of the video (i.e., encoded video signals at various bit rates), but advantageously uses stored metadata from one or more previous generations to generate subsequent additional encoded copies. In a second scenario in accordance with another illustrative embodiment of the present invention, a first encoder is used to generate a first encoded copy of the video, but a second encoder is used to generate the additional encoded copies.

This second illustrative scenario may be advantageously employed in connection with video signals transmitted across a mobile wireless network. In such networks, the “backhaul” link between a Radio Network Controller and a Base Transceiver Station (BTS) is bandwidth limited, but typically all traffic is sent over that link on its way to a mobile terminal. Although techniques in which a modified BTS with local storage and the capability of delivering content directly to a mobile terminal without the content traversing the backhaul link have been previously proposed, the amount of data sent to satisfy a single user is actually greater when MBR video is required, if all copies are preemptively sent over the backhaul. In accordance with an illustrative embodiment of the present invention, however, a single copy of an encoded video with metadata may be advantageously sent through the backhaul link to the modified BTS, where the additional encoded copies of the video can then be (locally) generated at different bit rates. In this way, a MBR video codec, which is quite efficient for the air interface between the BTS and the mobile terminal, can be made efficient for the backhaul link as well. Note that this technique would typically save roughly 50-70% of the backhaul required for each video. Without use of the metadata in accordance with the principles of the present invention, the modified BTS would have the added burden of doing full video encoding on the many videos sent to it every day, and would be less practical. In accordance with the above-described illustrative embodiment of the present invention, however, network bandwidth is advantageously traded off for CPU cycles on the modified BTS.

Note that other uses of the principles of the present invention may become important as video over wireless and video applications over IP networks evolve, since the principles of the present invention address the growing number of devices that are capable of recording video, but may not currently have the computational power required to encode MBR video. For example, in accordance with one such illustrative embodiment of the present invention, a video capable cell phone might advantageously record and upload a video to a local BTS that then generates multiple copies. In such an approach, the impact of MBR video on the reverse link bandwidth and the CPU cycles on the cell phone are being advantageously reduced. The local BTS or some other network element can then process the original video to generate the appropriate MBR video copies.

Finally, note that, in general, the principles of the present invention advantageously reduce bandwidth and CPU cycles, with the flexibility to trade off the two, and, moreover, advantageously distribute the encoding processes “arbitrarily” to various devices without merely running parallel, separate encoders. In particular, typically the metadata advantageously consumes far less bandwidth than multiple copies of the video data, and, moreover, the principles of the present invention advantageously speeds the encoding process performed in the subsequent encodings by eliminating duplicate computations already performed by earlier encoding(s).

### Addendum to the Detailed Description

It should be noted that all of the preceding discussion merely illustrates the general principles of the invention. It will be appreciated that those skilled in the art will be able to devise various other arrangements, which, although not explicitly 5 described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for generating a plurality of video encodings of a video source signal at a corresponding plurality of different bit rates, the method comprising the steps of:
(a) generating a first one of said plurality of video encodings of said video source signal at a first bit rate, wherein said generation of said first one of said video encodings comprises
(i) generating a first encoded video signal for use by a video decoder, and
(ii) generating and storing metadata derived during said generation of said first encoded video signal, wherein said metadata is not included in said first encoded video signal; and
(b) generating a subsequent one of said video encodings of said video source signal at a bit rate different from the first bit rate, wherein said generation of said subsequent one of said video encodings is based on said video source signal and on said stored metadata.

2. The method of claim 1 wherein said plurality of video encodings of the video source signal are each performed using a block-based motion-compensated video encoding technique, and wherein said metadata comprises block motion search information.

3. The method of claim 2 wherein said block motion search information comprises motion vectors and corresponding error information associated therewith.

4. The method of claim 1 wherein said plurality of video encodings comprise three or more video encodings, wherein said subsequent one of said video encodings of said video source signal comprises a second one of said video encodings of said video source signal at a second bit rate and wherein said second one of said video encodings of said video source signal comprises
(i) generating a second encoded video signal for use by a video decoder, and
(ii) generating and storing additional metadata derived during said generation of said second encoded video signal, wherein said metadata is not included in said second encoded video signal,
and wherein said method further comprises generating a third one of said video encodings of said video source signal at a bit rate different from the first bit rate and different from the second bit rate, wherein said generation of said third one of said video encodings is based on said video source signal and on said stored additional metadata.

5. A method for generating a first video encoding of a video source signal at a first bit rate, the first video encoding for use in performing one or more subsequent video encodings of said video source signal at one or more corresponding bit rates different from said first bit rate, the method comprising the steps of:
generating a first encoded video signal for use by a video decoder; and
generating and storing metadata derived in said generation of said first encoded video signal, wherein said metadata is not included in said first encoded video signal, said metadata for use in said performing of said one or more subsequent video encodings of said video source signal.

6. The method of claim 5 wherein said first video encoding of the video source signal is performed using a block-based motion-compensated video encoding technique, and wherein said metadata comprises block motion search information.

7. The method of claim 6 wherein said block motion search information comprises motion vectors and corresponding error information associated therewith.

8. The method of claim 5 further comprising the step of transmitting said metadata across a communications channel for use in performing said one or more subsequent video encodings of said video source signal.

9. A method for generating a subsequent video encoding of a video source signal at a specified bit rate, said subsequent video encoding based on a previously performed video encoding of said video source signal performed at a bit rate different from said specified bit rate, the previously performed video encoding of said video source signal having generated a first encoded video signal for use by a video decoder and having further generated and stored metadata derived during said generation of said first encoded video signal, wherein said metadata is not included in said first encoded video signal, the method comprising the step of:
generating the subsequent video encoding of said video source signal based on said video source signal and on said stored metadata.

10. The method of claim 9 wherein said subsequent video encoding of the video source signal is performed using a block-based motion-compensated video encoding technique, and wherein said metadata comprises block motion search information.

11. The method of claim 10 wherein said block motion search information comprises motion vectors and corresponding error information associated therewith.

12. The method of claim 9 further comprising the step of receiving said metadata via a communications channel from an encoder which performed said previously performed video encoding of said video source signal.

13. An encoder apparatus for generating a first video encoding of a video source signal at a first bit rate, the first video encoding for use in performing one or more subsequent video encodings of said video source signal at one or more corresponding bit rates different from said first bit rate, the encoder apparatus comprising:
means for generating a first encoded video signal for use by a video decoder; and
means for generating and storing metadata derived by said means for generating said first encoded video signal, wherein said metadata is not included in said first encoded video signal, said metadata for use in said performing of said one or more subsequent video encodings of said video source signal.

14. The encoder apparatus of claim 13 wherein the first video encoding of the video source signal is performed using a block-based motion-compensated video encoding technique, and wherein said metadata comprises block motion search information.

15. The encoder apparatus of claim 14 wherein said block motion search information comprises motion vectors and corresponding error information associated therewith.

16. The encoder apparatus of claim 13, further comprising means for transmitting said metadata across a communications channel for use in performing said one or more subsequent video encodings of said video source signal.

17. An encoder apparatus for generating a subsequent video encoding of a video source signal at a specified bit rate, said subsequent video encoding based on a previously performed video encoding of said video source signal performed at a bit rate different from said specified bit rate, the previously performed video encoding of said video source signal having generated a first encoded video signal for use by a video decoder and having further generated and stored metadata derived in said generation of said first encoded video signal, wherein said metadata is not included in said first encoded video signal, the encoder apparatus comprising:
means for receiving said stored metadata; and
means for generating the subsequent video encoding of said video source signal based on said video source signal and on said received metadata.

18. The encoder apparatus of claim 17 wherein said subsequent video encoding of the video source signal is performed using a block-based motion-compensated video encoding technique, and wherein said metadata comprises block motion search information.

19. The encoder apparatus of claim 18 wherein said block motion search information comprises motion vectors and corresponding error information associated therewith.

20. The encoder apparatus of claim 17 wherein the means for receiving said metadata comprises means for receiving said metadata via a communications channel from an encoder apparatus which performed said previously performed video encoding of said video source signal.
